(19) United States
(12) Patent Application Publication
(10) Pub. No.: US 2025/0243747 A1
(43) Pub. Date: Jul. 31, 2025

(54) Ultra-Sonic Acoustic Method For Through Casing Cement Evaluation

(71) Applicant: Halliburton Energy Services, Inc., Houston, TX (US)

(72) Inventor: Mark Collins, Houston, TX (US)

(73) Assignee: Halliburton Energy Services, Inc., Houston, TX (US)

(21) Appl. No.: 18/423,622

(22) Filed: Jan. 26, 2024

(51) Int. Cl. E21B 47/005; E21B 47/085; G01V 1/46; G01V 1/50

(52) U.S. Cl. CPC E21B 47/005; E21B 47/085; G01V 1/46; G01V 1/50

(57) ABSTRACT

A method and a system comprising disposing an acoustic logging tool into a wellbore, wherein the acoustic logging tool comprises an acoustic transmitter, an acoustic transducer, and/or an acoustic receiver; transmitting one or more acoustic waveforms from the acoustic logging tool with the acoustic transmitter or the acoustic transducer. Additionally, the method and system may be configured for recording one or more reflected acoustic waveforms at the acoustic logging tool with the acoustic receiver or the acoustic transducer; separating a first echo segment and a reverberation segment of a reflected waveform from the one or more reflected acoustic waveforms; and performing an inversion on at least the first echo segment, wherein the inversion comprises: producing a casing thickness.

### BACKGROUND

For oil and gas exploration and production, a network of wells, installations and other conduits may be established by connecting sections of metal pipe together. For example, a well installation may be completed, in part, by lowering multiple sections of metal pipe (i.e., a conduit string) into a wellbore, and cementing the conduit string in place. At the end of a well installations' life, the well installation may be plugged and abandoned. Understanding cement bond integrity to a conduit string may be beneficial in determining how to plug the well installation.

At the end of a well installations' life, the well installation may be plugged and abandoned. Understanding cement bond integrity may be beneficial in determining how to plug the well installation. Evaluating cement behind casing using acoustic waveforms has always been a challenging problem due to the large impedance contrast between the borehole fluid and casing. Because of the large impedance contrast, most of the incident energy from an acoustic source is reflected off the inner surface of the casing. Only a small amount of the incident energy penetrates the casing and probes the second interface bounding the annular fill material. Consequently, exciting a casing resonance is necessary to acquire information about the annulus material from the received waveform.

Currently, ultra-sonic acoustic tools generally consist of pulse-echo and/or pitch-catch. In either case, due to the large contrast between the borehole fluid and casing impedance, the excited acoustic casing mode is considerably more sensitive to borehole mud properties than annulus material properties. Other environmental factors such as casing curvature and thickness, and the size and geometry of the transducer relative to the casing are just as important in characterizing the modes as the annular material properties. Furthermore, knowledge of the excitation spectrum of the transducer is needed to deduce the material properties of the annulus using forward modeling inversion.

Thus, forward modeling inversion becomes difficult without knowledge of the mud properties downhole, knowledge of the transducer excitation spectrum, and insufficient fidelity in the physics model used to describe the acoustic mode.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates an example information handling system;

FIG. 3 illustrates another example information handling system;

FIG. 4 is a schematic showing potential ray paths of energy from cement-formation interface according to some embodiments of the present disclosure;

FIG. 5 shows a workflow for pulse-echo cement evaluation;

FIG. 6 shows pulse-echo waveform components;

FIG. 7 shows spectra of a pulse-echo waveform and a reverberation segment of a pulse-echo waveform as a function of frequency;

FIG. 8 shows an objective function for 1D pulse-echo waveforms;

FIG. 9 shows the interaction of the inversion methods A and B with the library;

FIG. 10 shows the workflow for the inversion methods A and B;

FIG. 11 shows the solid-fluid hypothesis testing workflow; and

FIG. 12 shows test and target waveforms for a 2D transducer model;

### DETAILED DESCRIPTION

Methods and systems herein may generally relate to methods and systems for forward modeling inversion and reducing required calibration factors. Additionally, the methods and systems discussed below may further invert transducer excitation while simultaneously inverting for annular compressional impedance, and in examples, inverting mud impedance. Methods and systems disclosed herein may utilize high fidelity physics frequency domain modeling in conjunction with a method for removing the reverberation interference from the recorded first echo segment. As a result of methods and systems disclosed herein, more accurate impedance estimates with minimal calibration create greater confidence in cement evaluation. Cement evaluation is utilized to determine the quality of a cement bond downhole. Identifying good quality cement bond is critical for zonal isolation which is needed for efficient hydrocarbon production and reducing environmental impact from hydrocarbon leakage.

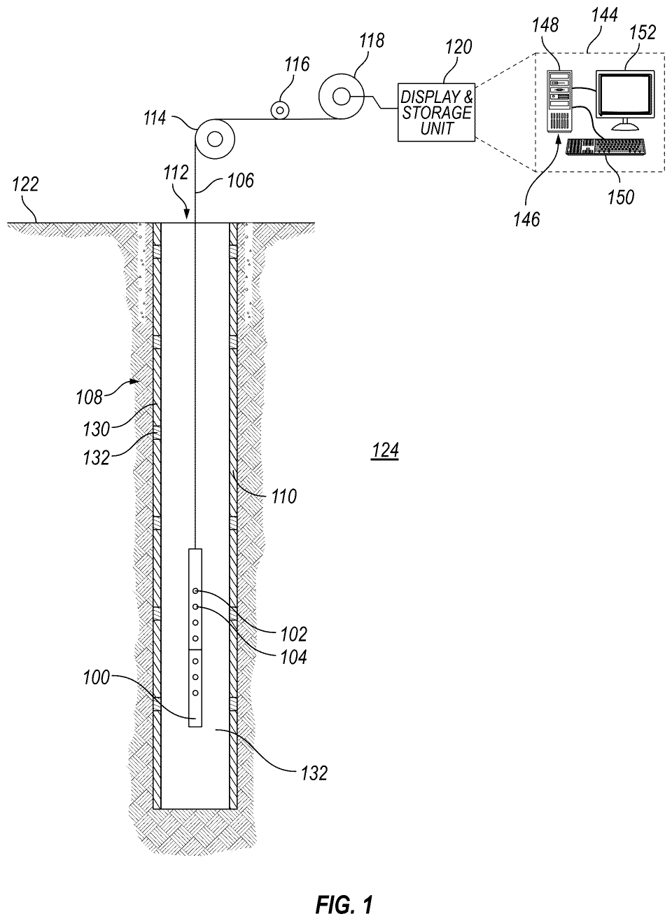

FIG. 1 illustrates an operating environment for an acoustic logging tool 100 as disclosed herein. Acoustic logging tool 100 may comprise a transmitter 102 and receiver 104. Additionally, transmitter 102 and receiver 104 may be configured to rotate in acoustic logging tool 100. In examples, there may be any number of transmitters 102 and/or any number of receivers 104, which may be disposed on acoustic logging tool 100. Additionally, transmitter 102 and receiver 104 may be configured to rotate in acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within conduit string 108 to a desired depth within the wellbore 110. Conveyance 106, which may include one or more electrical conductors, may exit wellhead 112, may pass around pulley 114, may engage odometer 116, and may be reeled onto winch 118, which may be employed to raise and lower the tool assembly in the wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and store for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical conduit string 108 may extend from wellhead 112 at or above ground level to a selected depth within a wellbore 110. Conduit string 108 may comprise a plurality of joints 130 or segments of conduit string 108, each joint 130 being connected to the adjacent segments by a collar 132.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to surface 122 during logging (corrosion detection).

Acoustic logging tool 100 may be used for excitation of transmitter 102. As illustrated, one or more receivers 104 may be positioned on the acoustic logging tool 100 at selected distances (e.g., axial spacing) away from transmitter 102. Specific examples of suitable transmitters 102 may include, but are not limited to, piezoelectric elements, bender bars, or other transducers suitable for generating acoustic waves downhole. Receiver 104 may include any suitable acoustic receiver suitable for use downhole, including piezoelectric elements that may convert acoustic waves into an electric signal. Further, transmitter 102 and receiver 104 may be combined into a single element with the ability to both transmit acoustic waves and receive acoustic waves, which may be identified as a transceiver.

Transmission of acoustic waves by the transmitter 102 into formation 124 and the recordation of signals by receivers 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process log data by executing software or instructions obtained from a local non-transitory computer readable media 148 (e.g., optical disks, magnetic disks). Non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

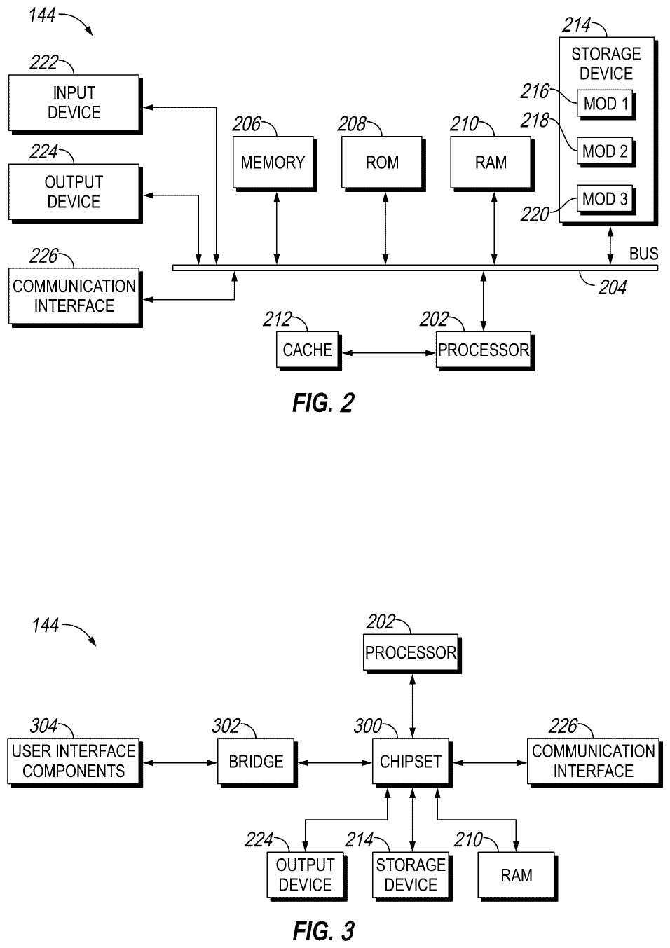

FIG. 2 illustrates an example information handling system 144 which may be employed to perform various steps, methods, and techniques disclosed herein. As illustrated, information handling system 144 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 144 may include a cache 212 of high-speed memory connected directly with, in close proximity to, or integrated as part of processor 202. Information handling system 144 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may include multiple different types of memory with different performance characteristics. It may be appreciated that the disclosure may operate on information handling system 144 with more than one processor 202 or on a group or cluster of computing devices networked together to provide greater processing capability. Processor 202 may include any general purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

The information handling system 144 may comprise a processor 202 that executes one or more instructions for processing the one or more measurements. The information handling system 144 may comprise processor 202 that executes one or more instructions for processing the one or more measurements. Information handling system 144 may process one or more measurements according to any one or more algorithms, functions, or calculations discussed below. In one or more embodiments, the information handling system 144 may output a return signal.

Processor 202 may include, for example a microprocessor, microcontroller, digital signal processor (DSP), application specific integrated circuit (ASIC), or any other digital or analog circuitry configured to interpret, execute program instructions, process data, or any combination thereof. Processor 202 may be configured to interpret and execute program instructions or other data retrieved and stored in any memory such as memory 206 or cache 212. Program instructions or other data may constitute portions of a software or application for carrying out one or more methods described herein. memory 206 or cache 212 may comprise read-only memory (ROM), random access memory (RAM), solid state memory, or disk-based memory. Each memory module may include any system, device or apparatus configured to retain program instructions, program data, or both for a period of time (e.g., computer-readable non-transitory media). For example, instructions from a software or application may be retrieved and stored in memory 206 for execution by processor 202.

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 144, such as during start-up. Information handling system 144 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 144 may include other hardware or software modules. Storage device 214 is connected to the system bus 204 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 144 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 222 represents any number of input mechanisms, such as a microphone for speech, a touch-sensitive screen for gesture or graphical input, keyboard, mouse, motion input, speech and so forth. Additionally, input device 222 may take in data from one or more sensors 136, discussed above. An output device 224 may also be one or more of a number of output mechanisms known to those of skill in the art. In some instances, multimodal systems enable a user to provide multiple types of input to communicate with information handling system 144. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 208 for storing software performing the operations described below, and random-access memory (RAM) 210 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 202 to perform particular functions according to the programming of software modules 216, 218, and 220.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 3 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. Bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 144 may come from any of a variety of sources, machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 144 receives inputs from a user via user interface components 304 and executes appropriate functions, such as browsing functions by interpreting these inputs using processor 202.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

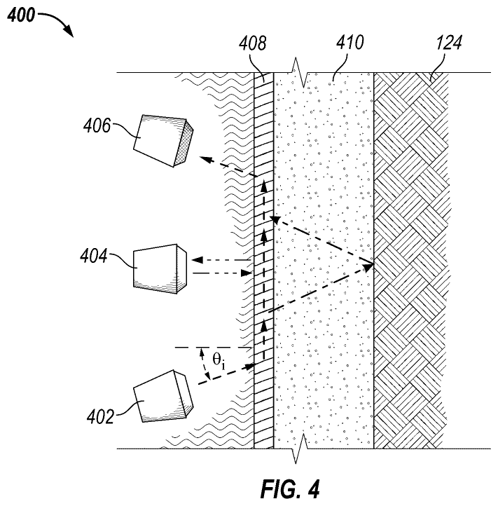

FIG. 4 is a schematic of a system 400 in which a pitch-catch (P-C) and pulse-echo (P-E) receiver configurations may be utilized by acoustic logging tool 100 (e.g., referring to FIG. 1) concurrently during measurement operations. As illustrated, potential ray paths of A₀ mode, leaked, and reflected A₀ energy from cement-formation interface are shown in accordance with measurement operations that may be performed and/or described in the present disclosure. During measurement operations, P-C Transmitter 402, which operates and functions according to the description above regarding transmitter 102, emits pulsed acoustic waves to obtain as reflected acoustic waves through P-C receiver 406 for cement evaluation. The distance between P-C transmitter 402 and P-C receiver 406 may be from about 0.1 inches to about 30 inches, or from about 4 inches to 27.5 inches, or from about 6 inches to 25 inches, or from about 8.5 inches to 20 inches and from about 10 inches to 19 inches according to embodiments of the present disclosure.

Additionally, P-E transceiver 404 may transmit ultrasonic or sonic acoustic waves into casing 408. The reflection of the acoustic waves, the echo, may be measured by P-E transceiver 404 as reflected acoustic waves for cement evaluation. Flexural attenuation is one of the cement evaluation measurements as flexural attenuation is a function of acoustic impedance on both sides of casing 408, and therefore depends on the material properties of cement 410 on the other side of casing 408 and is sensitive to the interface between cement 410 and formation 412. To obtain a flexural attenuation measurement, an ultrasonic acoustic downhole tool may emit pulses in the range of a few hundred kilohertz, for example. The cement 410 sheath behind casing 408 is evaluated by sending a short pressure pulse toward casing 408 wall that excites elastic waves inside casing 408. The propagation of these waves is strongly affected by casing 408—cement 410 bond quality and the cement 410 properties. An acoustic beam at oblique incidence onto casing 408 excites modes of the family of Lamb waves, which are predominantly the zeroth-order antisymmetric (flexural) and symmetric (extensional) modes. Based on the zeroth-order antisymmetric (flexural) mode response, such as the flexural attenuation, the quality of cement 410 installation may be estimated. These wave modes are collected using the pitch-catch source and receiver combinations oriented appropriately governed by dispersion equations detailed below.

When casing 408 is excited using acoustic waves (ultrasonic and/or sonic) incident on it at angles necessary to generate flexural wave mode in casing 408, some portion of the energy leaks into the annulus and gets reflected by the cement-formation interface. If there are defects in the annulus in between casing and cement-formation interface, some energy also gets reflected by those defects. These reflected acoustic waves may travel to P-C receiver 408 and the defects may create a signature waveform, separate and apart from all other captured waveforms, that may be studied. If one waveform from each acquisition at every depth and azimuth is taken and all such waveforms are displayed together after sorting based on depth or azimuth, then a structural image of the annulus may be created and interpreted. Such an image may be a time domain image because of the waveforms being time domain traces. Cement evaluation for P-E techniques may be described below.

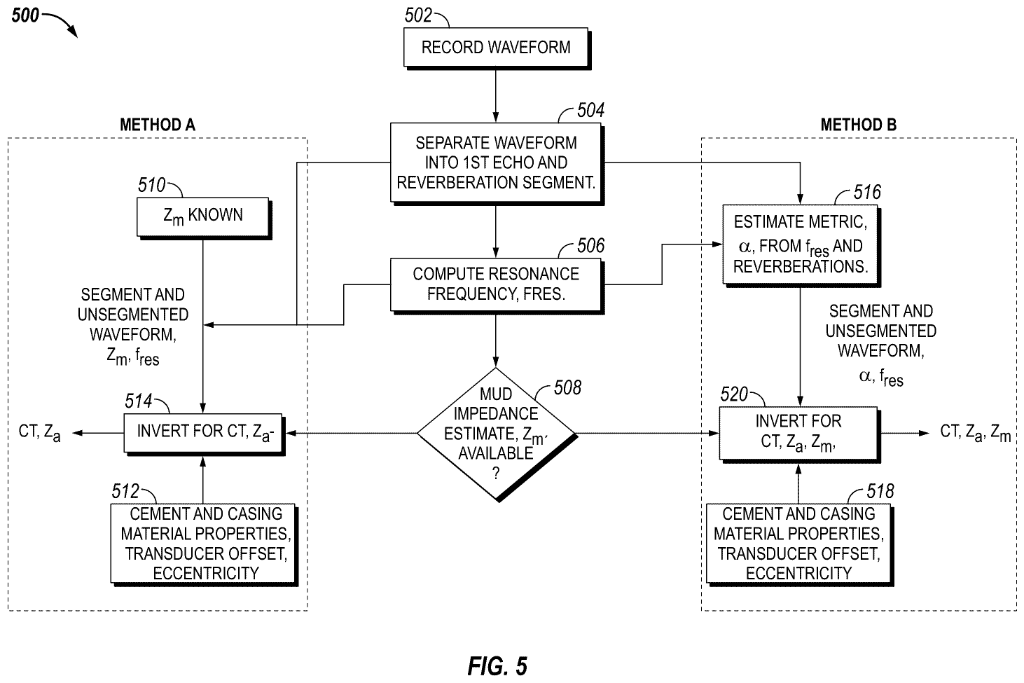

FIG. 5 illustrates a workflow 500 for cement evaluation of reflected acoustic waves obtained by P-E techniques. Workflow 500 is at least partially performed on information handling system 144. Workflow 500 may begin with block 502. In block 502, measurement operations may be performed by recording waveforms of reflected acoustic waves using P-E transceiver 404 (e.g., referring to FIG. 4), as described above, of acoustic logging tool 100. Specifically, pulse echo measurements may be performed by P-E transceiver 404, which may transmit an acoustic wave into an area of interest. The acoustic wave propagates through the borehole fluid, reflects off the casing, and propagates back towards P-E transducer 404 where it is recorded and digitized. The transmitted acoustic wave may comprise an initial high amplitude first echo resulting from the incident wave reflecting off the inner surface of the casing, followed by a reverberation section caused by the casing resonance. The reverberation section may be processed to determine information about the material in the annulus region behind the casing. The start of the reverberation section may be approximately delayed by the two-way travel time in the casing. This delay is typically much less than the duration of the first echo, so there is an intermediate time interval where the first echo and reverberations interfere with one another. After the reflected acoustic wave has been recorded, it is segmented into two parts, a first echo segment and a reverberation segment. The first echo segment may be at least as long as the duration of the true first echo (i.e., first echo segment without reverberation interference), but not so long that the inversion for annular material properties becomes ill-posed due to insufficient information in the reverberation segment.

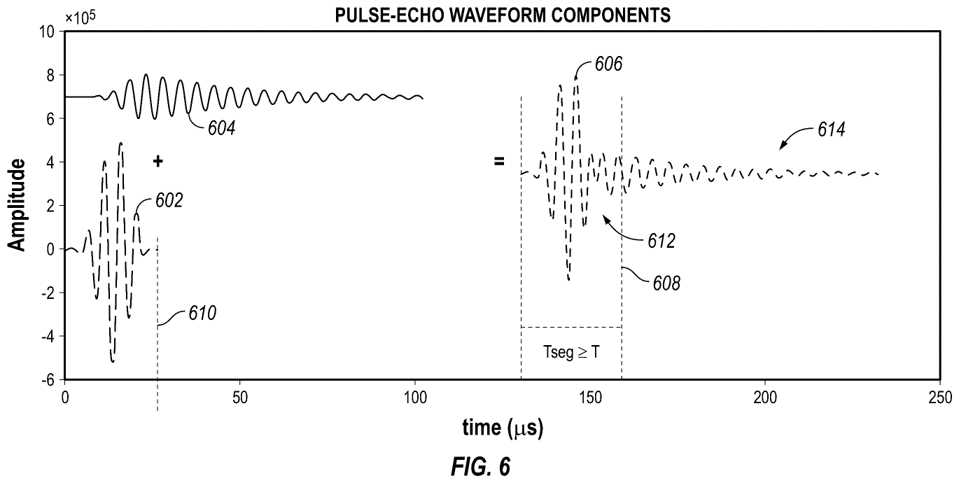

FIG. 6 illustrates the true first echo 602, reverberations 604, and total reflected acoustic wave 606 which is the sum of the true first echo 602 and reverberations 604 in the time domain. Additionally, FIG. 6 illustrates a segmentation time 608 separating the total waveform into a first echo segment 612 containing total reflected acoustic wave 606 and a reverberation segment 614. Segmentation time 608 may be computed in several ways. For instance, the envelope of the waveform may be computed. Then a first reference time may be determined as the point where the envelope first rises above a threshold. The peak of the envelope may be computed as a second reference point approximately in the middle of the first echo. Approximately half of the time duration of the first echo may be computed as the difference in time, Δτ, of the two reference points. From the second reference point one advances by the time difference, Δτ, to approximately the end of the first echo. The actual waveform one advances in time to the next zero of the waveform. Then as an additional buffer one may advance to the N'th zero of the waveform after the current zero, where N is a small constant number (0, 1, or 2). In examples, segmentation time 608 may be greater than or at least equal to the time 610 of true first echo 602 so that the removal of total reflected acoustic wave 606 from the first echo segment 612 may be performed. Conversely, the time should not be so long that the inversion for annular material properties becomes ill-posed due to insufficient information in reverberations 604. In examples, the reverberation segment may be five resonance periods long of reverberations 604.

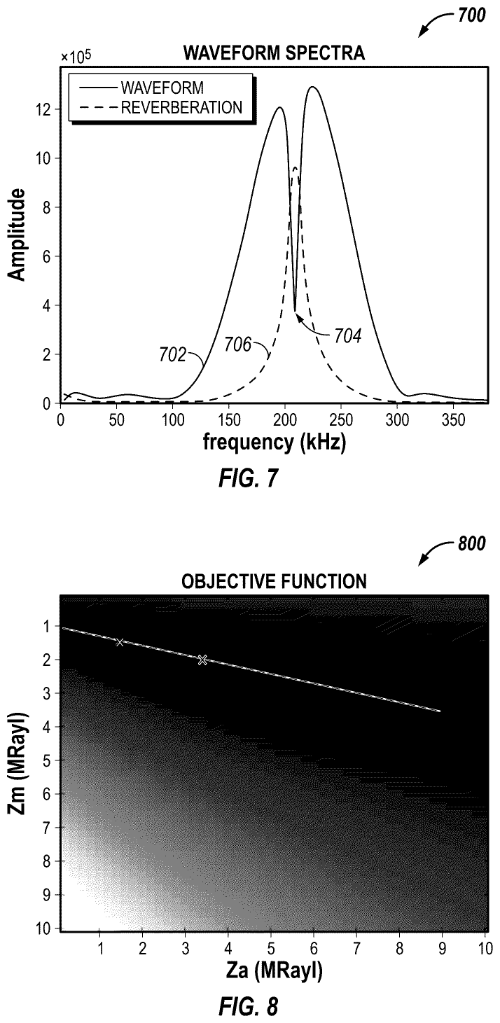

Referring back to FIG. 5, in block 504 segmentation time 608 (e.g., referring to FIG. 6) may be calculated in order to separate first echo segment 612 from reverberation segment 614. In examples, reverberation segment 614 of and total reflected acoustic wave 606 may be caused by the casing resonance. FIG. 7 illustrates frequency domain waveform spectra 700. Full waveform spectrum 702 has a notch 704. Notch 704 may be identified where the amplitude drops sharply between two maxima amplitudes of the waveform. Additionally, reverberation spectrum 706 may help identify notch 704. For example, notch 704 may be at the resonance frequency. Thus, the reverberation spectrum 706 may cross notch 704 and have a peak at the resonance frequency. In examples, notch 704 may be at the resonance frequency. Reverberation spectrum 706 may have a peak at the resonance frequency. Referring back to FIG. 5, in block 506, the resonance frequency, ƒᵣₑₛ, may be computed from the position of notch 704 in the full waveform spectrum 702, or the position of the peak in reverberation spectrum 706 by any standard technique. Once a resonance frequency is computed it is passed on to the remaining cement evaluation workflow 500. The shape of the spectra in the region of the resonance frequency gives information about the compressional impedance of the annular material behind the casing. Cement bond quality is determined by inverting true first echo 602 or first echo segment 612 for the impedance. High values indicate well bonded cement. Low values indicate poorly bonded cement or fluid. Very low values indicate gas. In block 508, it is determined if an estimate for mud impedance, Zₘ, exists from external sources or may be computed.

Mud impedance is the product of mud density and velocity. If there is an available estimate for mud impedance, Zₘ, or it may be accurately computed in method A. In block 510 of method A, a mud property measurement may be performed by any standard technique to determine mud impedance, Zₘ. For example, it may be possible to estimate mud velocity, Vₘ, based on the arrival time of true first (e.g., referring to FIG. 6) and the transducer offset from the borehole wall. Additionally, using an empirical relationship to determine mud density from velocity, temperature, and pressure based on mud-type may allow for computation of the mud impedance. If the mud impedance is available in block 510, invert for annular impedance, Zₐ, and casing thickness, CT, but not mud impedance. This is referred to as Method A. For example, in block 514 the initial estimate for casing thickness may be computed as the first step in the inversion. In examples, casing thickness may be computed by using the flat plate formula of equation (1):

$$C T = \frac{{V}_{SC}}{2 {f}_{res}} = \frac{{V}_{SC} {T}_{res}}{2} \qquad Equation ( 1 )$$

Herein, V_{SC} is the known compressional velocity of the steel casing and Tᵣₑₛ is the resonance period, i.e., 1/ƒᵣₑₛ. The casing thickness inversion is restricted to a narrow region centered on the initial estimate of casing thickness. In block 512, downhole properties needed for the inversion in block 514 such as cement properties, casing properties, transducer offset, eccentricity, and/or the like may be acquired.

However, if a reliable mud measurement is not available, it may be preferable to invert for both mud impedance Zₘ, and annular impedance Zₐ, as well as casing thickness, CT. This is Method B in process 582. As motivation for the first embodiment of Method B which will be described later, consider the objective function 800 illustrated in FIG. 8.

Referring to FIG. 8, objective function 800 was computed from the L2 norm of the difference between a target pulse-echo waveform with Zₘ=Zₐ=1.5 MRayl and other pulse echo waveforms with different values of mud impedance and annulus impedance. The waveforms may be computed in the 1D model approximation, i.e., normal incidence plane wave reflecting off a flat plate. It is well known that impedance estimates from pulse-echo data require calibration when the 1D reflectivity model is used for the inversion since it neglects transducer size and casing curvature effects, but for purposes of this discussion it is adequate. Objective function 800 shows the waveforms are much more sensitive to mud impedance Zₘ than to annulus impedance Zₐ, so inverting for both without constraint any noise or parameter uncertainties may result in a large variation of annular impedance. Referring back to FIG. 5, method B, block 516, may compute metric, α, from reverberation segment 614 (e.g., referring to FIG. 6) that constrains the inversion for mud and annular impedance to a 1D inversion over a curve in the (Zₘ, Zₐ) parameter space. This enhances both stability and speed of the inversion. The choice of metric is motivated by analyzing the 1D reflectivity model (not to be confused with the 1D inversion mentioned above) of a pulse-echo waveform spectrum, W(ω), of Equation (2):

$$W ( ω ) = S ( ω ) R ( ω ) \qquad Equation ( 2 )$$

Herein ω is angular frequency, and S(ω) is a spectral shaping function that accounts for the transmitted drive pulse spectrum, receiver electronics, and the two-way propagation through the borehole fluid. Further, the flat plate 1D model reflectivity, R(ω), is defined in Equation (3):

$$R ( ω ) = {R}_{m} - \frac{4 {Z}_{m} {Z}_{S} {R}_{a}}{{( {Z}_{m} + {Z}_{a} )}^{2} ( z - {R}_{m} {R}_{a} )} ≡ {R}_{m} + {R}_{rev} ( ω ) \qquad Equation ( 3 )$$

Herein, Rₘ₍ₐ₎ are the half-space reflectivities defined in Equation (4) below:

$${R}_{m ( a )} = \frac{{Z}_{m ( a )} - {Z}_{s}}{{Z}_{m ( a )} + {Z}_{s}} , \qquad Equation ( 4 )$$

where Z_{S} is the impedance of the flat plate steel casing. z is a phasor determined by Equation (5):

$$z = exp [ j ω {T}_{res} ] , \qquad Equation ( 5 )$$

z is a complex phasor, and Rᵣₑᵥ(ω) as defined in Equation (3) is the part of the reflectivity associated with the reverberations.
Within this model, the true first echo spectrum, W_{TFE}(ω), may be determined in Equation (6):

$${W}_{TFE} ( ω ) = S ( ω ) {R}_{m} \qquad Equation ( 6 )$$

and the reverberation spectrum, Wᵣₑᵥ(ω), may be determined in Equation (7):

$${W}_{rev} ( ω ) = S ( ω ) {R}_{rev} ( ω ) \qquad Equation ( 7 )$$

Using the 1D model equations described above, it may be shown (because of the pole in the reverberation part of the reflectivity at z=RₘRₐ) that the reverberations are periodic with periodicity Tᵣₑₛ=1/ƒᵣₑₛ after the end of the true first echo waveform. Furthermore, the reverberations in a time interval [T₁, T₂] after the first echo are nothing but a copy of the reverberations in the previous time interval [T₁−Tᵣₑₛ, T₂−Tᵣₑₛ] scaled by the factor RₘRₐ. These statements are valid independent of the shape of the true first echo. Thus, within the 1D model approximation a useful attribute/metric is defined in Equation (8):

$$α ≡ {R}_{m} {R}_{a} = \frac{{\sum }_{{T}_{1}}^{{T}_{2}} \vert W \vert}{{\sum }_{{T}_{1}}^{{T}_{2}} \vert {W}_{sh} \vert} \qquad Equation ( 8 )$$

where the time interval [T₁, T₂] spans several periods in the reverberation segment of the waveform. Additionally, waveform Wₛₕ is the original waveform W shifted to later time by time shift Tᵣₑₛ in Equation (9):

$${W}_{sh} ( t ) = W ( t - {T}_{res} ) \qquad Equation ( 9 )$$

Since the earliest time used has to be later than the end of the true first echo, T, the following relationship may be established in equation (10):

$${T}_{1} > T + {T}_{res} \qquad Equation ( 10 )$$

Different time intervals [T₁, T₂] may be used and averaged to get a more robust estimate. The time intervals do not have to be an integer number of periods. The metric may also be estimated using other methods. Another embodiment would consist in taking the ratio of the Fourier transform of the waveform intervals evaluated at the resonance frequency ƒᵣₑₛ in Equation (11):

$$α ≡ {R}_{m} {R}_{a} = \frac{F F T ( W \cdot Wts ) {\vert}_{{f}_{res}}}{F F T ( {W}_{sh} \cdot Wts ) {\vert}_{{f}_{res}}} \qquad Equation ( 11 )$$

A short FFT may be used and the value at ƒᵣₑₛ determined by interpolation. The weights, Wts, limit the waveform to the desired interval. As noted previously, the attribute defined above actually equals RₘRₐ only for waveforms consistent with the 1D reflectivity model. The 1D model is only approximate for actual waveforms because of casing curvature and finite transducer size. However, for real data the attribute may still be used as defined above to constrain the inversion for a given test annular impedance as in Equation (12):

$$α ≡ \frac{{\sum }_{{T}_{1}}^{{T}_{2}} \vert W \vert}{{\sum }_{{T}_{1}}^{{T}_{2}} \vert {W}_{sh} \vert} = f ( {Z}_{a , test} , {Z}_{m} , … ) \qquad Equation ( 12 )$$

α is a fixed value measured from the waveform. For each test annular impedance, the above equation is solved for the test mud impedance, Z_{m,test}, thus constraining the inversion over Zₐ and Zₘ to 1D over a curve in the (Zₘ, Zₐ) parameter space (2D if the bounded inversion over CT is considered).

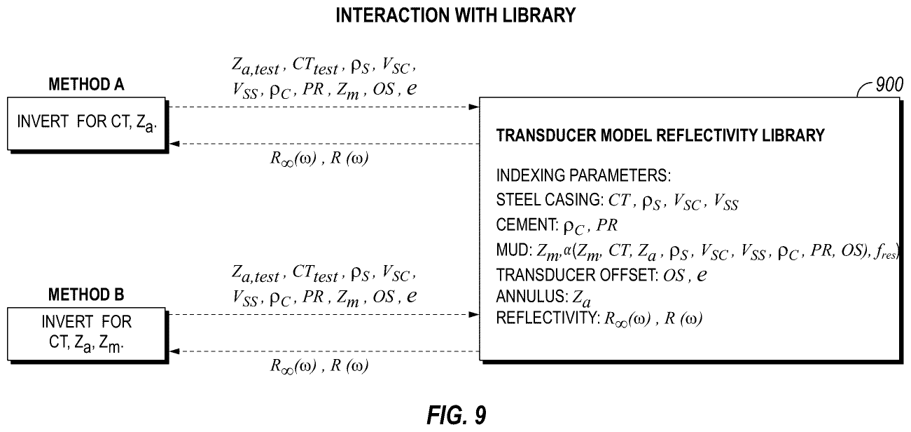

The actual form of the function, ƒ. Instead, a high-fidelity reflectivity library may be created as a function of frequency, mud and annular impedance, casing thickness, offset, and other parameters based on lab measurements and accurate modeling. In examples 3D modeling may be done using finite difference or finite element modeling applications. In the preferred embodiment this model should be more accurate than the 1D reflectivity model and account for the effects of casing curvature, transducer size, and position relative to the casing. Recall α is independent of S(ω) for the 1D reflectivity model. Under the assumption that the attribute α remains reasonably independent of S(ω) for higher fidelity models select a reasonable representative S(ω) for the transducer, compute the resonance frequency and a for each frequency dependent reflectivity in the library, and store the resonance frequency and a as part of the library as in FIG. 9. The development of the library is done in advance of the well logging, so the impedance inversion will be fast. When performing inversions on real data a is estimated from the data and then for a given test annular impedance the mud impedance corresponding to the same a is selected, resulting in a 1D inversion.

FIG. 9 illustrates method A and method B interacting with a transducer reflectivity model library 900. The reflectivities are R_{∞}(ω) and R(ω), where R_{∞}(ω) is the reflectivity for a cylindrical casing of infinite thickness (outer radius at infinity) and R(ω) is the reflectivity for a cylindrical casing with finite thickness CT. The waveforms are related to the reflectivities in Equation (13):

$$W ( ω ) = S ( ω ) R ( ω ) = S ( ω ) {R}_{∞} ( ω ) + S ( ω ) {R}_{rev} ( ω ) \qquad Equation ( 13 )$$

Additionally, Rᵣₑᵥ(ω) may be further defined in Equation (14):

$${R}_{rev} ( ω ) ≡ R ( ω ) - {R}_{∞} ( ω ) , \qquad Equation ( 14 )$$

and the true first echo spectrum may be defined in Equation (15) as:

$${W}_{TFE} ( ω ) = S ( ω ) {R}_{∞} ( ω ) . \qquad Equation ( 15 )$$

Herein, S(ω) accounts for the transmitted drive pulse and receiver electronics spectral shape, but not the effect of the non-planar acoustic wave at a given frequency propagating through the borehole fluid and interacting with the finite size transducer, which in some examples is now included in the more realistic reflectivity model as a weighted sum of acoustic sources on transmit and a weighted sum of acoustic amplitudes on receive over the transducer face. The transmit and receive weights are defined for a specific transducer type. Previously in the 1D model the definition of S(ω) included the effect of propagating through the borehole fluid, which in the 1D case is just a trivial linear phase shift and attenuation as a function of frequency. The redefinition of S(ω) does not affect the method of incorporating a described earlier.

Reflectivity model library 900 implies the chosen attribute is insensitive to the spectrum shape, S(ω), since the library is a response to an impulse in time. Insensitivity to the spectrum shape was the primary motivation for attribute α described above since it makes the inversion faster and more stable if attribute α is independent of the excitation. Attribute α is completely insensitive in the context of the 1D model and should remain predominately so for actual waveforms and higher fidelity reflectivity models. However, correcting for possible sensitivity of attribute α to S(ω) may incorporate several methods. One of the features of the proposed inversion method that will be described shortly is the ability to invert for shape S(ω) from the first echo segment as part of the inversion for Zₐ (and Zₘ for method B). Consequently, if attribute α has dependence on S(ω), attribute α may be incorporated in the inversion process as well to account for the dependence.

An alternative method of correcting for possible sensitivity of α to S(ω) incorporates additional attributes in the reflectivity model library 900 computed from the spectrum S(ω). These attributes are used to parametrize the relationship between α and Zₘ., e.g., α=ƒₛ(Z_{a,test}, Zₘ, . . . ), where's would be at least one attribute of the spectrum. One example of the attribute(s) may be the center frequency and bandwidth of S(ω). At each iteration of the inversion attributes are computed from the current estimated S(ω) and these are used to look-up the value of Z_{m,test} for the fixed measured a of the waveform. In examples, the number of parameters needed to select a reflectivity pair is large. Steel casing parameters needed are casing thickness, density, and compressional and shear velocities. The latter three are treated as known values, and we invert for casing thickness over a small, bounded range. There are two hypotheses for the annular material. It is treated as a material that does not support shear (fluid or gas), or it is treated as a solid. If it is treated as a solid it is assumed that the density changes little during the curing process, and Poisson's ratio, PR, gradually decreases during the curing process. Both variables are assumed known based on cement type and curing stage, leaving the compressional impedance Zₐ, as the remaining variable. In block 518, the transducer properties include the eccentricity, e, relative to borehole center, and the transducer offset OS, relative to the inner surface of the casing. These are assumed known based on caliper measurements. An inversion workflow may be provided below.

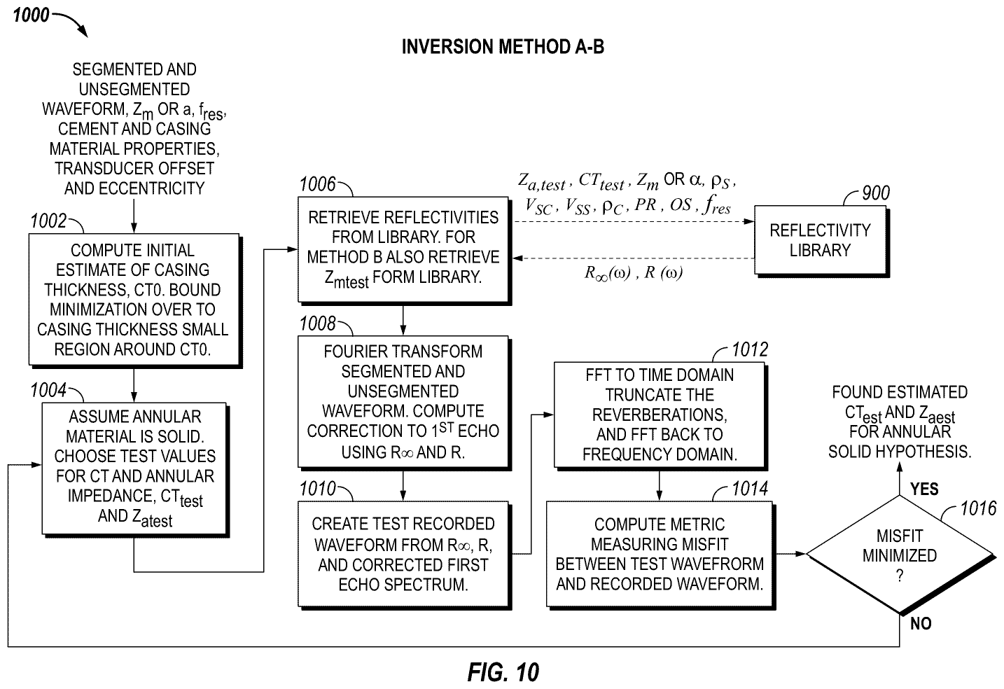

FIG. 10 illustrates the inversion workflow 1000 for method A or B of FIG. 9 corresponding to blocks 514 and 520 in processes 580 and 582 of FIG. 5 respectively. In examples, inversion workflow 1000 may be performed on information handling system 144. Method A assumes Zₘ is known and inverts for Zₐ and CT. Method B inverts for all three, Zₘ, Zₐ, and CT using a constraint, α, estimated from the reverberations to reduce the dimensionality of the inversion. Inputs to inversion workflow 1000 may include mud impedance Zₘ or metric α, cement properties, casing properties, transducer offset, eccentricity, resonance frequency ƒᵣₑₛ, the full unsegmented waveform, first echo segment 612 (e.g., referring to FIG. 6), and reverberation segment 614 from blocks 504, 506, 510, 512, 516, and/or 518 (e.g., referring to FIG. 5). In block 1002, the initial estimate for casing thickness, CTO may be computed from Equation (1). Bounds for the casing thickness inversion may be defined as in Equation (16):

$$CT 0 - Δ CT < {CT}_{test} < CT 0 + Δ CT , \qquad Equation ( 16 )$$

where ΔCT is a small constant of several hundredths of an inch. In block 1004, it may be assumed that the annular material is solid. Further, a test annular compressional impedance, Zₐₜₑₛₜ, and test casing thickness, CTₜₑₛₜ, may be selected. In some examples the initial test casing thickness is (TO. In other examples it may be any casing thickness within the bounds specified in Equation (16). Any reasonable initial test impedance may be selected. In some examples the initial test impedance is set to Zₘ. In block 1006, a test annular compressional impedance Zₐₜₑₛₜ, test casing thickness CTₜₑₛₜ, and/or mud impedance Zₘ for method A, or metric α for method B together with other inputs may be sent to reflectivity model library 900 (shown in FIGS. 9 and 10) to retrieve the reflectivities, R_{∞}(ω) and R(ω), as described in FIG. 9. In Method B, the test mud impedance Z_{m,test} is also retrieved from reflectivity model library 900.

In block 1008, a Fourier transform of the first echo segment and unsegmented waveforms may be performed. The unsegmented spectrum W(ω) may be the target spectrum for the inversion. The spectrum of the first echo segment W_{FE}(ω) may be corrected in 1008 to estimate the true first echo W_{TFE}(ω) under the assumption that the test impedances and test casing thickness are true. Under this assumption, true first echo W_{TFE}(ω) as defined by equation (15) may be accurately estimated by Equation (17):

$${W}_{TFE} ( ω ) = [ {U}_{FE} * ( {W}_{FE} \cdot [ 1 - {r}_{rev , test} ] ) ] \qquad Equation ( 17 )$$

where U_{FE} is the spectrum of the unit square wave mask used to capture the first echo segment, r_{rev,test} is the normalized reverberation reflectivity, and * is the convolution operator in the frequency domain. Note this approximation works very well as long as the duration of the mask is at least as long as the true first echo. Additionally, the normalized reverberation reflectivity r_{rev,test}(ω) is defined in Equation (18):

$${r}_{rev , test} ( ω ) ≡ \frac{R ( ω )}{{R}_{∞} ( ω )} - 1 \qquad Equation ( 18 )$$

Using the spectrum of the corrected first echo spectrum, i.e., the estimated true first echo segment W_{TFE}(ω), in block 1010 a test waveform spectrum Wₜₑₛₜ(ω) may be calculated in Equation (19):

$${W}_{test} ( ω ) = [ {U}_{FE} * ( {W}_{FE} \cdot [ 1 - {r}_{rev , test} ] ) ] \cdot [ 1 + {r}_{rev , test} ] . \qquad Equation ( 19 )$$

The recorded waveform is of necessity recorded over a finite time interval. Thus, before comparing the test spectrum to the target spectrum W(ω) in block 1014, block 1012 applies an inverse FFT to the test spectrum, truncates it in the time domain to the same duration as the recorded target waveform, then FFTs the test waveform back to the frequency domain. In other examples, block 1012 may be implemented by convolution as in Equation (20):

$${W}_{test} ( ω ) = {U}_{RW} * ( [ {U}_{FE} * ( {W}_{FE} \cdot [ 1 - {r}_{rev , test} ] ) ] \cdot [ 1 + {r}_{rev , test} ] ) , \qquad Equation ( 20 )$$

where U_{RW} may be the spectrum of the mask applied to match the duration of the test waveform and recorded target wave.

In further examples, the test and target waveforms are automatically aligned in time, so no time shifting is necessary before comparing the target data waveforms to the test waveform. In block 1014, the waveform spectra may be compared by computing and minimizing an objective function. In examples, an objective function may be the L2 norm of the difference between attributes computed from test waveform spectrum Wₜₑₛₜ(ω) and the target W(ω). Other norms are also possible such as the absolute value of the difference. There are numerous embodiments for computing the attributes. Acceptable attributes are the complex spectra in the region near the resonance, group delay in the region near the resonance, or the waveform amplitudes in the time domain. The attribute α computed from the test and recorded waveform may be compared in the objective function instead of using it as a constraint.

In block 1016, different test impedance and casing thickness parameters may be tried and blocks 1004-1014 may be repeated until the objective function is minimized. In examples, it may be possible to match test and target attributes using a few iterations of the Newton Raphson method. This defines the estimated impedances(s) and casing thickness under the hypothesis that the annular material is a solid. Once the objective function is minimized, test compressional impedance Zₐₜₑₛₜ and test casing thickness CTₜₑₛₜ from block 1014 may be set as final impedance and casing thickness values. Standard techniques may be implemented to determine cement bond from compressional impedance and casing thickness. If the cement bond is not proficient at a given depth, then a remediation plan may be implemented. Herein, a proficient cement bond may be 100%-75% full bonded, 75%-25% fully bonded, or 25%-1% fully bonded. Remediation procedures may be implemented to correct for non-proficient cement bonds. In examples, remediations procedures may include oil excavation, soil vapor extraction, soil vapor extraction with air sparge, in-situ chemical oxidation, groundwater extraction and treatment through mechanical, chemical or biological means, and dual phase extraction. Additionally, one or more remediation operations may be identified and performed on the wellbore. General remediation may be performed by a downhole squeeze job. In some examples, for wellbore remediation, coiled tubing may deliver the remediation chemicals to the location of non-ideal cement bond. Further, remediation operations such as squeeze jobs, chemical remediations, oil excavation, soil vapor extraction, soil vapor extraction with air sparge, in-situ chemical oxidation, groundwater extraction and treatment through mechanical, chemical or biological means, and dual phase extraction, and/or the like may be performed to improve or at least partially repair one or more non-ideal cement bonds. Additionally, hypothesis testing may be performed.

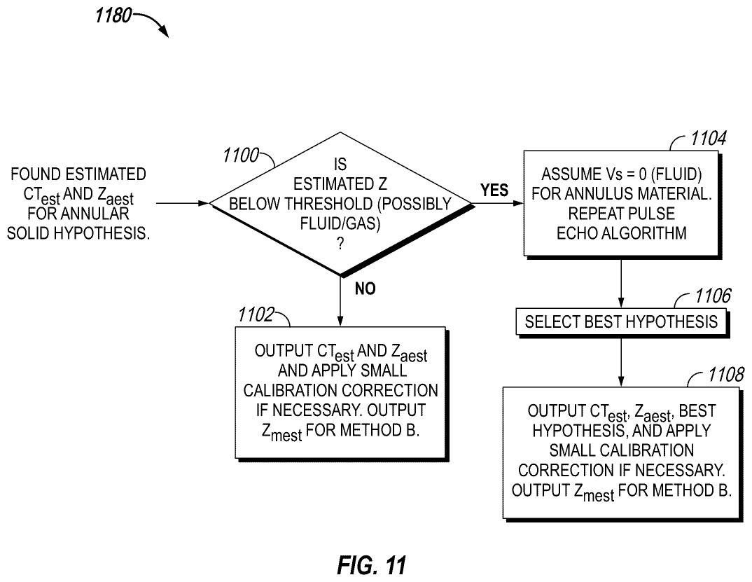

FIG. 11 shows the solid hypothesis testing 1180. In examples, solid hypothesis testing 1180 may be performed on information handling system 144 (e.g. referring to FIG. 1). In block 1100 it is determined whether the estimated annular impedance Z is below a threshold. In block 1102, if the estimated annular impedance is not below a threshold, then the solid hypothesis is assumed correct since cements usually have larger impedances than fluids. However, if the annular impedance is below the threshold, then the solid hypothesis needs to be tested. In block 1104, the pulse echo algorithm is repeated under the hypothesis that the annular material is a fluid (zero shear velocity). The annular density is taken to be the mud density. In block 1106, the results from the two hypotheses are compared and the impedance(s) and casing thickness estimates from the best hypothesis are selected as the final estimate. In block 1108, a calibration correction is applied if necessary. A good reflectivity library may require a small correction or none at all. If the best estimate of impedance is very low gas is assumed, and if desired, the density is adjusted accordingly to a reasonable low value and the impedance estimate is repeated. Multiple embodiments may determine the ‘best’ hypothesis. In addition, an embodiment may utilize external information to surmise which hypothesis is correct. For example, which hypothesis is more likely can be determined by comparing the results to CBL logs or attenuation logs from the A0 flexural mode since solids have greater attenuation than fluids due to shear wave coupling. Further, a 2D transducer model may be utilized.

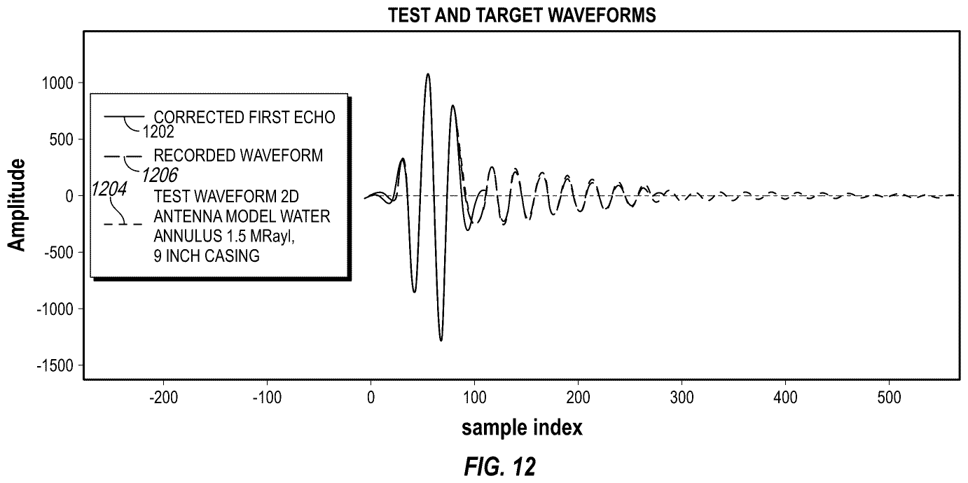

FIG. 12 illustrates an example using a 2D transducer model. The model test waveform 1204 and recorded target waveform 1206 match well and are nearly identical up to the end of the recorded waveform. The corrected first echo 1202 is also shown. A second embodiment of the inversion process for Method B creates a look-up table for the mud and annular impedance based on estimating two attributes of the recorded waveforms. These attributes are motivated by the form of the 1D reflectivity model. Recall,

$$W ( ω ) = S ( ω ) R ( ω ) , \qquad Equation ( 2 )$$

$$where$$

$$R ( ω ) = {R}_{m} - \frac{4 {Z}_{m} {Z}_{S} {R}_{a}}{{( {Z}_{m} + {Z}_{a} )}^{2} ( z - {R}_{m} {R}_{a} )} ≡ {R}_{m} + {R}_{rev} ( ω ) , \qquad Equation ( 3 )$$

the half-space reflectivities are

$${R}_{m ( a )} = \frac{{Z}_{m ( a )} - {Z}_{s}}{{Z}_{m ( a )} + {Z}_{s}} , \qquad Equation ( 4 )$$

$$and$$

$$z = exp [ j ω {T}_{res} ] . \qquad Equation ( 5 )$$

Z_{S} is the impedance of the flat plate steel casing, and S(ω) accounts for the transmitted drive pulse spectrum, receiver electronics, and the two-way propagation through the borehole fluid. Using the 1D model in the equation for normalized reverberation reflectivity gives Equation (21):

$${r}_{rev , test} ( ω ) ≡ \frac{R ( ω )}{{R}_{∞} ( ω )} - 1 = \frac{{R}_{rev} ( ω )}{{R}_{m}} = - \frac{4 {Z}_{m} {Z}_{S} {R}_{a}}{{{R}_{m} ( {Z}_{m} + {Z}_{a} )}^{2} ( z - {R}_{m} {R}_{a} )} ≡ \frac{{β}_{1 D}}{( z - {α}_{1 D} )} . \qquad Equation ( 21 )$$

In the above equation the terms (α_{1D}, β_{1D}) are the pole position and residue of the casing resonance. Similarly, we may define a pole position and residue, (α,β), as attributes of the recorded waveform by breaking the dependance on the impedances given by the 1D model,

$${r}_{rev , test} ( ω ) ≡ \frac{β}{( z - α )} . \qquad Equation ( 22 )$$

Recall, the values of the attributes are determined by the best fit of the test waveform,

$${W}_{test} ( ω ) = {U}_{RW} * ( [ {U}_{FE} * ( {W}_{FE} \cdot [ 1 - {r}_{rev , test} ] ) ] \cdot [ 1 + {r}_{rev , test} ] ) , \qquad Equation ( 20 )$$

to the recorded waveform. Defining p(ω)≡(z−α)⁻¹, the test wave may be expressed at given frequency, ω, by Equations (23-26):

$${W}_{test} ( ω ) = a ( ω ) {β}^{2} + b ( ω ) β + c ( ω ) , \qquad Equation ( 23 )$$

$$where$$

$$a ( ω ) = - {U}_{RW} * ( p \cdot {U}_{FE} * ( p \cdot {W}_{FE} ) ) , \qquad Equation ( 24 )$$

$$b ( ω ) = [ {U}_{RW} * ( p \cdot {W}_{FE} - {U}_{FE} * ( p \cdot {W}_{FE} ) ) ] , \qquad Equation ( 25 )$$

$$and$$

$$c ( ω ) = {W}_{FE} . \qquad Equation ( 26 )$$

Given (ƒᵣₑₛ, α), β may be determined by minimizing the objective function of Equation (27):

$$O = {\sum }_{k = {k}_{1}}^{{k}_{2}} {\vert {a}_{k} {β}^{2} + {b}_{k} β + {c}_{k} - W ( {ω}_{k} ) \vert}^{2} , \qquad Equation ( 27 )$$

where W is the recorded waveform, subscript k indicates a specific frequency, ωₖ, and the frequencies are in the neighborhood of the resonance frequency. This results in solving for the physical root of the cubic polynomial in Equation (28):

$$d {β}^{3} + e {β}^{2} + f β + g = 0. \qquad Equation ( 28 )$$

The polynomial coefficients are given by Equations (30-33):

$$d = 2 {\sum }_{k = 1 {k}_{1}}^{{k}_{2}} {\vert {a}_{k} \vert}^{2} , \qquad Equation ( 29 )$$

$$e = 3 {\sum }_{k = {k}_{1}}^{{k}_{2}} Re ( {a}_{k}^{*} {b}_{k} ) , \qquad Equation ( 30 )$$

$$f = {\sum }_{k = {k}_{1}}^{{k}_{2}} [ {\vert {b}_{k} \vert}^{2} + 2 Re ( {a}_{k}^{*} ( {c}_{k} - W ( {ω}_{k} ) ) ) ] , \qquad Equation ( 31 )$$

$$g = {\sum }_{k = {k}_{1}}^{{k}_{2}} Re ( {b}_{k}^{*} ( {c}_{k} - W ( {ω}_{k} ) ) ) . \qquad Equation ( 32 )$$

The resonance frequency, ƒᵣₑₛ=1/Tᵣₑₛ, and pole position, α, used to solve equation (28) are estimated as described previously in FIG. 5 blocks 506 and 516. Hold parameter a fixed or further optimize α and β by using the original estimate of a as a seed for further minimization of the objective function expressed in Equation (27). Different test values of a in a small, bounded region centered on the seed value of a are used to solve Equation (28) for the test values of β and the corresponding objective function values. The test values of α and β that minimize the objective function over the set of test values determines the estimated α and β. The attributes α and β are incorporated in the reflectivity library as was done for a alone in the previous described. The estimated values for the mud and annular impedances for method B are determined by matching the estimated α and β to the nearest library values.

Improvements discussed above may comprise improving the capability of forward modeling inversion and reducing required calibration factors. For example, inverting transducer excitation while simultaneously inverting for annular compressional impedance, and in examples inverting mud impedance. For example, high fidelity physics frequency domain modeling may be utilized in conjunction with a method for removing the reverberation interference from the recorded first echo segment. As a result of methods and systems disclosed herein, more accurate impedance estimates with minimal calibration create greater confidence in the cement evaluation. Good quality cement bond is critical for zonal isolation which is needed for efficient hydrocarbon production and reducing environmental impact from hydrocarbon leakage.

The systems and methods for using a distributed acoustic system in a subsea environment may include any of the various features of the systems and methods disclosed herein, including one or more of the following statements. Additionally, the systems and methods for an acoustic tool in a downhole environment may include any of the various features of the systems and methods disclosed herein, including one or more of the following statements.

Statement 1. A method comprising disposing an acoustic logging tool into a wellbore, wherein the acoustic logging tool comprises an acoustic transmitter, an acoustic transducer, and/or an acoustic receiver; transmitting one or more acoustic waveforms from the acoustic logging tool with the acoustic transmitter or the acoustic transducer; recording one or more reflected acoustic waveforms at the acoustic logging tool with the acoustic receiver or the acoustic transducer; separating a first echo segment and a reverberation segment of a reflected waveform from the one or more reflected acoustic waveforms; and performing an inversion on at least the first echo segment, wherein the inversion comprises: producing a casing thickness.

Statement 2. The method of claim 1, further comprising acquiring one or more downhole properties for the inversion, wherein one or more downhole properties comprise cement properties, casing properties, transducer offset, and/or eccentricity.

Statement 3. The method of statement 2, further comprising compute metric α from the reverberation segment.

Statement 4. The method of statement 3, wherein metric α constrains the inversion for mud and annular impedance to a 1D inversion over a curve.

Statement 5. The method of statement 4, wherein the inversion utilizes the metric α to produce a compressional impedance.

Statement 6. The method of statement 5, wherein the inversion further comprises choosing a casing thickness test value and an annular impedance test value.

Statement 7. The method of statement 6, wherein the inversion further comprises retrieving one or more reflectivities with the mud impedance, the casing thickness test value, and the annular impedance test value with a reflectivity model library.

Statement 8. The method of statement 7, wherein the inversion further comprises determining a test waveform based at least on the one or more reflectivities, casing thickness test value, and the annular impedance test value.

Statement 9. The method of statement 8, wherein the inversion further comprises determining a difference, wherein the difference is a comparison between the test waveform to the reflected waveform from the one or more reflected acoustic waveforms.

Statement 10. The method of statement 9, wherein the inversion further comprises determining cement bond with the casing thickness test value and the annular impedance test value.

Statement 11. The method of statement 10, further comprising performing a remediation plan based on the cement bond.

Statement 12. The method of statement 2, further comprising determining a mud impedance.

Statement 13. The method of statement 12, wherein the inversion utilizes the mud impedance to produce a compressional impedance.

Statement 14. A system comprising: an acoustic logging tool, wherein the acoustic logging tool comprises: an acoustic transmitter, wherein the acoustic transmitter is configured to transmit one or more acoustic waveforms from the acoustic logging tool; and an acoustic receiver, wherein the acoustic receiver is configured to record one or more reflected acoustic waveforms at the acoustic logging tool; and an information handling system communicability coupled to the acoustic logging tool, wherein the information handling system is configured for: separating a first echo segment and a reverberation segment of a reflected waveform from the one or more reflected acoustic waveforms; and performing an inversion on at least the first echo segment, wherein the inversion comprises: producing a casing thickness.

Statement 15. The system of statement 14, further comprising determining a mud impedance.

Statement 16. The system of statement 15, wherein the inversion utilizes the mud impedance to produce a compressional impedance.

Statement 17. The system of statement 16, wherein the inversion further comprises choosing a casing thickness test value and an annular impedance test value and comprises retrieving one or more reflectivities with the mud impedance, the casing thickness test value, and the annular impedance test value with a reflectivity model library.

Statement 18. The system of statement 17, wherein the inversion further comprises determining a test waveform based at least on the one or more reflectivities, casing thickness test value, and the annular impedance test value, wherein the inversion further comprises determining a difference, wherein the difference is a comparison between the test waveform to the reflected waveform from the one or more reflected acoustic waveforms.

Statement 19. The system of statement 18, wherein the inversion further comprises determining that the difference between the reflected waveform from the one or more reflected acoustic waveforms is minimized if the difference is below a threshold.

Statement 20. The system of statement 19, wherein the inversion further comprises determining cement bond with the casing thickness test value and the annular impedance test value.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

1. A method comprising:
disposing an acoustic logging tool into a wellbore, wherein the acoustic logging tool comprises an acoustic transmitter, an acoustic transducer, and/or an acoustic receiver;
transmitting one or more acoustic waveforms from the acoustic logging tool with the acoustic transmitter or the acoustic transducer;
recording one or more reflected acoustic waveforms at the acoustic logging tool with the acoustic receiver or the acoustic transducer;
separating a first echo segment and a reverberation segment of a reflected waveform from the one or more reflected acoustic waveforms; and
performing an inversion on at least the first echo segment, wherein the inversion comprises:
producing a casing thickness.

2. The method of claim 1, further comprising acquiring one or more downhole properties for the inversion, wherein one or more downhole properties comprise cement properties, casing properties, transducer offset, and/or eccentricity.

3. The method of claim 2, further comprising compute metric α from the reverberation segment.

4. The method of claim 3, wherein metric α constrains the inversion for mud and annular impedance to a 1D inversion over a curve.

5. The method of claim 4, wherein the inversion utilizes the metric α to produce a compressional impedance.

6. The method of claim 5, wherein the inversion further comprises choosing a casing thickness test value and an annular impedance test value.

7. The method of claim 6, wherein the inversion further comprises retrieving one or more reflectivities with the mud impedance, the casing thickness test value, and the annular impedance test value with a reflectivity model library.

8. The method of claim 7, wherein the inversion further comprises determining a test waveform based at least on the one or more reflectivities, casing thickness test value, and the annular impedance test value.

9. The method of claim 8, wherein the inversion further comprises determining a difference, wherein the difference is a comparison between the test waveform to the reflected waveform from the one or more reflected acoustic waveforms.

10. The method of claim 9, wherein the inversion further comprises determining cement bond with the casing thickness test value and the annular impedance test value.

11. The method of claim 10, further comprising performing a remediation plan based on the cement bond.

12. The method of claim 2, further comprising determining a mud impedance.

13. The method of claim 12, wherein the inversion utilizes the mud impedance to produce a compressional impedance.

14. A system comprising:
an acoustic logging tool, wherein the acoustic logging tool comprises:
an acoustic transmitter, wherein the acoustic transmitter is configured to transmit one or more acoustic waveforms from the acoustic logging tool; and
an acoustic receiver, wherein the acoustic receiver is configured to record one or more reflected acoustic waveforms at the acoustic logging tool; and
an information handling system communicability coupled to the acoustic logging tool, wherein the information handling system is configured for:
separating a first echo segment and a reverberation segment of a reflected waveform from the one or more reflected acoustic waveforms; and
performing an inversion on at least the first echo segment, wherein the inversion comprises:
producing a casing thickness.

15. The system of claim 14, further comprising determining a mud impedance.

16. The system of claim 15, wherein the inversion utilizes the mud impedance to produce a compressional impedance.

17. The system of claim 16, wherein the inversion further comprises choosing a casing thickness test value and an annular impedance test value and comprises retrieving one or more reflectivities with the mud impedance, the casing thickness test value, and the annular impedance test value with a reflectivity model library.

18. The system of claim 17, wherein the inversion further comprises determining a test waveform based at least on the one or more reflectivities, casing thickness test value, and the annular impedance test value, wherein the inversion further comprises determining a difference, wherein the difference is a comparison between the test waveform to the reflected waveform from the one or more reflected acoustic waveforms.

19. The system of claim 18, wherein the inversion further comprises determining that the difference between the reflected waveform from the one or more reflected acoustic waveforms is minimized if the difference is below a threshold.

20. The system of claim 19, wherein the inversion further comprises determining cement bond with the casing thickness test value and the annular impedance test value.
